(19) United States
(12) Patent Application Publication
(10) Pub. No.: US 2005/0264470 A1
(43) Pub. Date: Dec. 1, 2005

(54) Variable size multi-pane display

(75) Inventors: Paulus Cornelis Neervoort, Eindhoven (NL); Robert Kortenoeven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/521,718

(22) PCT Filed: Jul. 1, 2003
(86) PCT No.: PCT/IB03/03102

§ 371 Date: Jan. 19, 2005

(30) Foreign Application Priority Data
Jul. 24, 2002 (EP) 02078012.8

(51) Int. Cl. G09G 5/00

(52) U.S. Cl. 345/1.1

(57) ABSTRACT

This invention relates to method of presenting content by means of a display unit (10) connected or attached to a media device (23-26). The invention further relates to a display unit for presenting content. The media device may be a personal computer, a television, a camera, a video camera, a game unit or a mobile unit. Said method includes the steps of: connecting or attaching the display unit to a first location relative to a media device; determining, by the media device, the first location of the display unit; determining, by the media device, a first information item representing content, wherein said first information item is dependent on said location and a content presented on the media device; transferring, by the media device, the first information item to the display unit; and receiving and presenting (i.e. displaying and/or playing back) said first in formation item oil the display unit. Said first information item may include plain text, pictures, frames, video, word-processor data, spread-sheet data, game figures, game elements, text or picture messages, or any combination thereof. Said step of determining the first location of the display unit includes the steps of transmitting, by at least one transmitter located on the display unit, at least one signal identifying said display unit; receiving, by at least one sensor (41) located on the media device, at least one identifying signal; and determining, by the media device, the first location based on at least one identifying signal. This allows content to be displayed and/or played back on a connected or attached display unit located relative to a media device, and where said content can intuitively and indirectly be determined by the user.

This invention relates to a method of presenting content by means of a display unit.

The present invention also relates to a computer system for performing the method.

The present invention further relates to a computer program product for performing the method.

This invention further relates to a display unit for presenting content.

U.S. Pat. No. 6,104,359 discloses an expanded computer desktop working area. A so-called forking driver is inserted logically between a graphical device interface program and a plurality of computer monitor display screens. Said forking driver can intercept a function call directed to the device driver program corresponding to the primary screen of said computer desktop and is then able to process the function call to cause device driver program(s) to change to screen(s) that is/are different from said primary screen.

However, the above prior art method involves the problem that it only deals with display screens similar to the primary screen of the computer desktop. Furthermore, the user of said system cannot easily determine, by relocating display screens, what he desires to have presented to him.

It is a further problem that in many display-related applications, screen space is being occupied by extra functionalities that are being presented through the use of toolbars, status-windows, frames, etc. Most content of these screen areas has a supporting functionality towards the main content. Consequently, it is a problem that screen space is lost to said supporting functionalities because of their presence and layout.

It is therefore an object of the present invention to make it easy for a user to select which content or which content part is to be displayed.

However, it is sometimes unsuitable to show a small content part from a primary screen on another screen or display of a comparable size.

In other cases it is also inconvenient to show a content part on a screen or a display of a too large size.

Conversely, in other cases it is unsuitable to show content on a display of a too small size.

It is therefore a further object of the present invention to present content or a content part from a primary screen on a display of a suitable size and/or layout.

The above objects are achieved by said method, wherein the method comprises the steps of:
connecting or attaching the display unit to a first location relative to a media device;
determining, by the media device, the first location of the display unit;
determining, by the media device, a first information item representing content, wherein said first information item is dependent on said location and a content presented on the media device;
transferring, by the media device, the first information item to the display unit; and
receiving and presenting said first information item on the display unit.

In the first step, it is possible for the user to position the display unit to any desirable location relative to a media device.

In the second step, the media device may find out that a display unit is connected or attached to it, and subsequently the media device may locate the display unit.

In the third step, said first information item is made dependent on the location of the display unit and content presented on the media device.

Said first information item may comprise plain text, pictures, frames, video, word-processor data, spread-sheet data, game figures, game elements, text or picture messages, or any combination thereof. This may reflect what is currently presented on the media device

In the fourth step, said information is then transferred to the display unit.

Finally, the information is received by the display unit and is then presented, i.e. displayed and/or played back, if possible.

By means of the first step in particular and the next steps in general, the object of making it easy to select which content (part) is to be displayed is achieved because the user will intuitively connect or attach the display unit to content or near by content on the media device, where said content can subsequently be displayed differently (larger, smaller, etc.) on said display unit.

It is therefore an advantage of the invention that a primary screen's space is extended, dependent on where the additional display unit is positioned with no further user interaction.

The further object of presenting content on a display of a suitable size and/or layout is achieved because the display unit may have different layouts, such as hexagonal, rectangular, triangular, circular, elliptic, etc.

In a preferred embodiment of the invention, the step of determining the first location of the display unit comprises the steps of:
transmitting, by at least one transmitter located on the display unit, at least one signal identifying said display unit;
receiving, by at least one sensor located on the media device, at least one identifying signal; and
determining, by the media device, the first location based on at least one identifying signal.

In the first of these steps, one or more transmitters positioned on or integrated in the display unit is/are used to identify it to the media device, because said signal or signals is or are currently transmitted from the display unit.

Consequently, in the second of the above-mentioned steps, said signal or signals is or are received by a sensor or sensors located on the media device.

Finally, by means of said signal or signals, the media device may locate coordinates for the display unit.

It is an advantage of the invention that a primary screen's space can be extended, and especially can be extended (by means of the display unit) dependent on where the additional display, i.e. the display unit, is located.

Furthermore it is an advantage that it is less expensive to buy a display unit than an additional, larger, more costly computer monitor.

The objects of the invention are further achieved by a display unit for presenting content, said display unit comprising:
means for connecting or attaching to a first location relative to a media device;
means for transmitting, by at least one transmitter located on the display unit, at least one signal identifying said display unit; and
means for receiving and means for presenting a first information item representing content, wherein the first information item is dependent on said location and a content presented on the media device, and wherein said first information item is sent from the media device.

The display unit gives the same advantages for the same reasons as described previously in relation to the method.

Display units may be small portable displays with a speaker, where these may be used to be attached or connected to monitors or the like to display specific on-screen content that would otherwise be displayed in windows or corners within the monitors main display's screen space.

In general, the idea of the present invention covers the automatic transfer of on-screen content from a parent display's screen, i.e. the display of a media device, to display units. The transfer of screen content may then occur automatically as soon as the display unit is connected to the main display's casing. The transferred on-screen content may consist of visual information and audio with supporting characteristics. These types of information may be found in applications such as games and tool panels in various software applications.

The display units are then used to display specific on-screen content that would otherwise be displayed in windows or corners of the media device's main display. On-screen content is then transferred from the main display of the media device to the display unit depending upon its location.

The invention will be explained more fully below in connection with preferred embodiments and with reference to the drawings, in which:

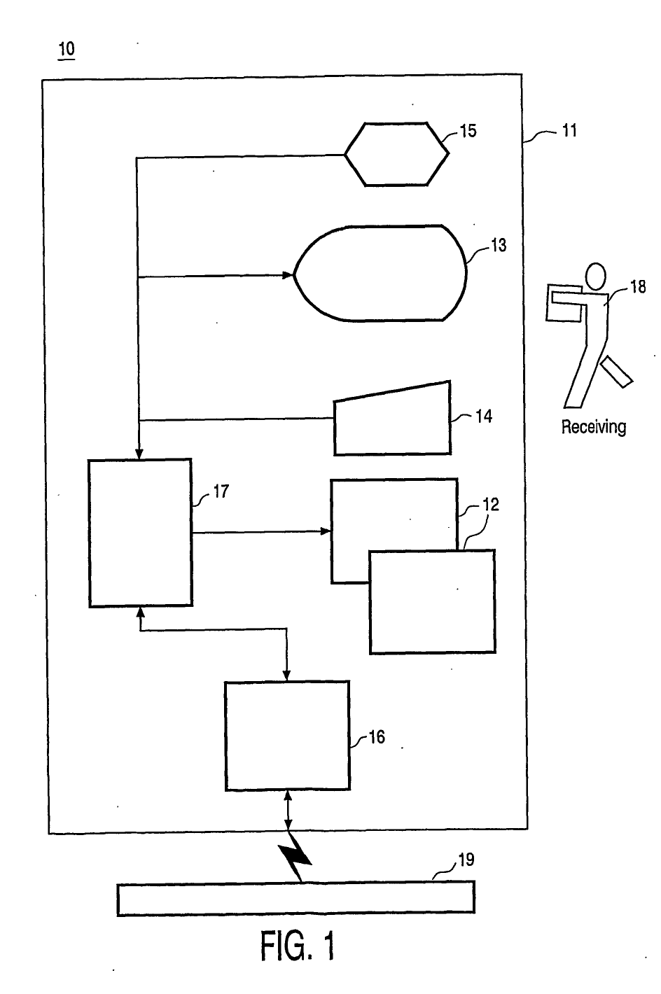

FIG. 1 shows a display unit;

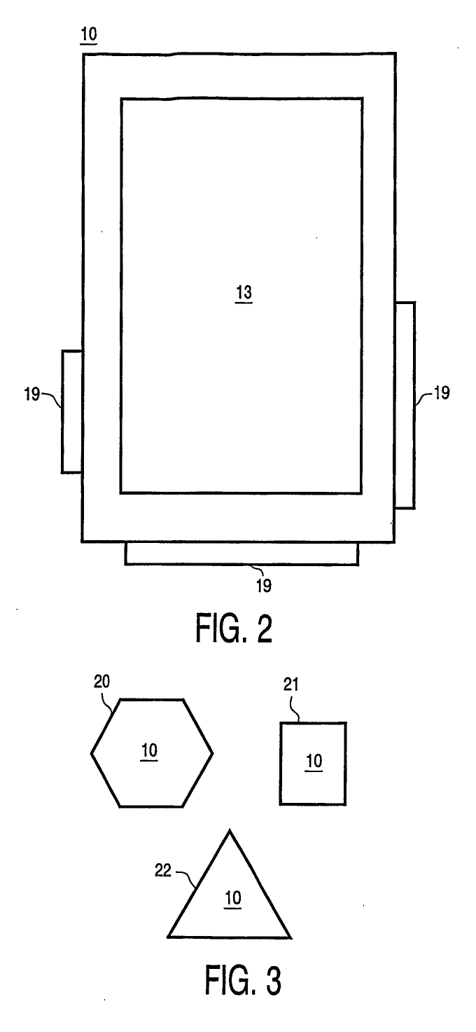

FIG. 2 shows a physical implementation of the display unit;

FIG. 3 shows various layouts of a display unit;

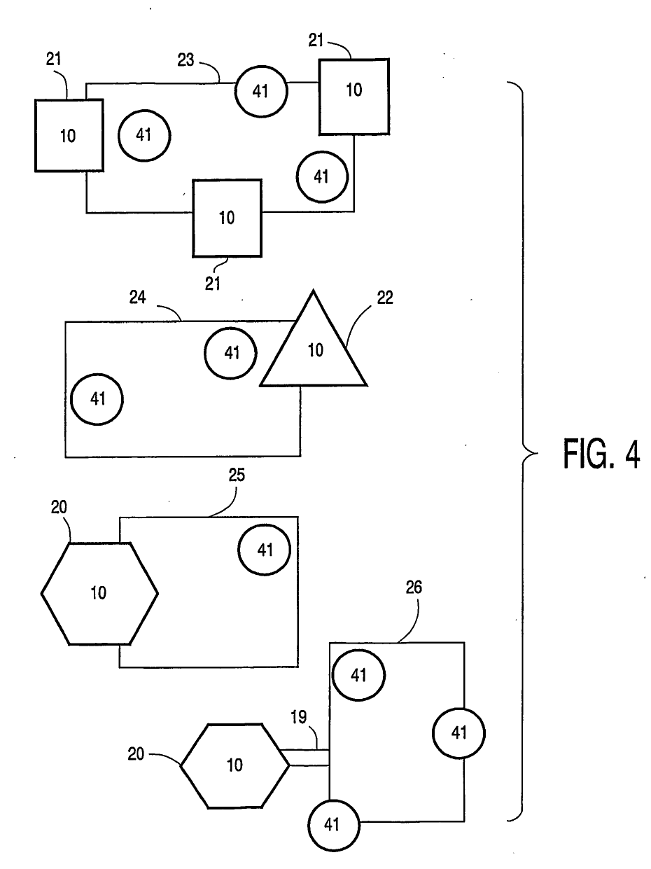

FIG. 4 shows various connections of various layouts of display units to media devices; and

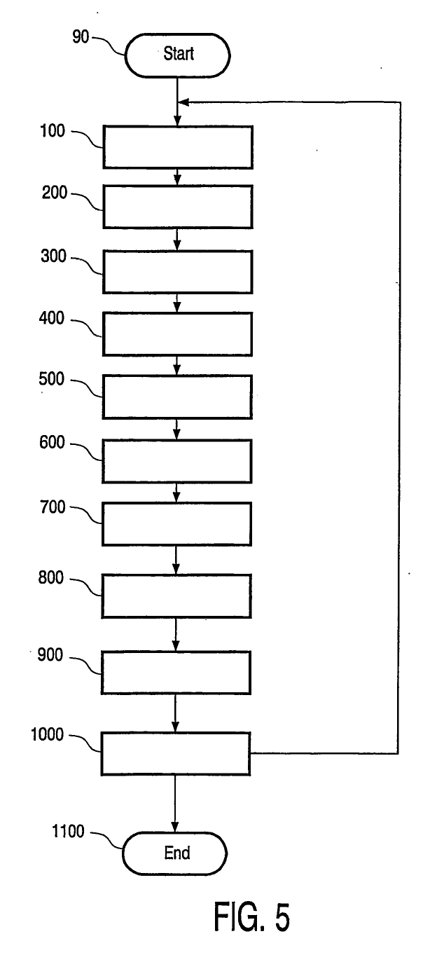

FIG. 5 shows a method of presenting content by means of a display unit.

Throughout the drawings, the same reference numerals indicate similar or corresponding features, functions, etc.

FIG. 1 shows a display unit. The display unit as shown by reference numeral 10 has a front as shown by reference numeral 11. Before said front, a user—as indicated by reference numeral 18—may obtain information from the display unit's display, reference numeral 13, and/or from a loudspeaker, reference numeral 15, each positioned on the front. Said information may be displayed on the display and said information, when it comprises sounds or music, may optionally or additionally be emitted by means of the loudspeaker 15 or on a like device. The display unit may be used and operated in conjunction with connections to other display units, with the intention to provide the user with an enlarged or different viewing area. In other words, the display unit may be connected to other units of the same kind, or connected to different units of other kinds, such as the display of a personal computer, the display of a television, the display of a camera or of a video camera, the display of a game unit, the display of a mobile telephone, etc. On the display unit or integrated in the display unit one or more transmitters 12 may be positioned.

This or these transmitters may then be used to inform another unit that said display unit is connected to it. The transmitter may be any sensor capable of transmitting a signal as known in the prior art, such as a signal of light, an infra-red signal, etc. Furthermore, said signal may be used to identify the display unit and its type. By means of said transmitters, the location of the display unit relative to a unit of the same kind, relative to other units or relative to a device on which said display unit is attached may be determined. When the location of the display unit is known, information—reflecting said location—may subsequently be transferred to the display unit for a subsequent presentation.

Said information may be plain text, pictures, frames, video, word-processor data, spread-sheet data, game figures, game elements, text or picture messages, and combinations thereof.

The user may respond to said information given by means of an input device, as shown by reference numeral 14. The input device may be a keyboard, some other pushbutton and/or fields sensitive to touch on said display. The input device may further be a button and or an arrangement of buttons, a pointing device, such as a mouse, a trackball, a touch pad, a digital pen, or the like.

Said information may—by means of the processor—be displayed and/or played back or redirected to another or other display units. The display unit may be connected physically by means of a connector, reference numeral 19, or logically by means of an identifier to other or different display units. It may therefore be appropriate that information dedicated to one display unit may be transferred through another display or other display units by means of a communication device, reference numeral 16, connected to a processor, reference numeral 17. The communication device may receive or send information by means of a network, e.g. a local area network (LAN), a wide area network (WAN), or any combination thereof, e.g. the Internet, an intranet, an extranet. The network may comprise wired and wireless communication links. Said network may be a general solution known from the prior art, or it may be dedicated to an optimized communication between said display unit and a media device; the combination of these two will be discussed further in FIG. 4. The communication device may communicate by means of said connector.

Said processor is arranged to receive inputs from the display, if it has touch-sensitive fields on its front, the input device and the communication device. The processor is further arranged to generate display data to the display, sound or music data to the speaker, signals to said transmitter(s) and other data to the communication device.

FIG. 2 shows a physical implementation of the display unit. In a preferred embodiment, the display area, i.e. the display unit's display, is large as compared to the physical layout of the display unit. More layouts will be shown in the next figure. Since it may be possible to connect the display unit to other devices, the physical layout of said connector may be of interest to the user. Said connector may also be a non-electrical connector, because it may be used to tie, configure, mount or fix the display unit to a like display unit, or it may be used to physically connect it to various units of other kinds, such as an additional display to a personal computer, a television, a (video) camera, a game unit, a mobile telephone, etc.

FIG. 3 shows various layouts of a display unit. Also here, in a preferred embodiment of the invention, the display area, i.e. the display unit's display may be large as compared to the shown layouts of the various, alternative physical display units. Reference numeral 20 shows a display unit in a hexagonal layout, alternatively, reference numeral 21 shows the display unit in a rectangular layout, and alternatively, reference numeral 22 shows the display unit in a triangular layout. It may further be possible to have the displays configured in other shapes, such as circular, elliptical, etc.

Furthermore, each of said display units may further have a stand, a base plate or a foot with means for physical contact or connection to a like display unit or to a different display unit of a media device. In said stand, base plate or foot, said connector—previously shown by reference numeral 19—may be an integral part.

FIG. 4 shows various connections of various layouts of display units to media devices. Reference numeral 25 shows a display unit in a hexagonal layout attached to the media device, alternatively, reference numeral 23 shows three display units, all of them in rectangular layouts attached to the media device, and reference numeral 24 shows the triangular display in a layout attached to the media device. Generally, according to a preferred embodiment of the invention, one or more display units may be attached to said media device. Typically, said display(s) will be attached close to or on the display area of said media device in order to provide the user with an overall larger viewing area than the viewing area of the media device. However, in reference numeral 26, the display unit in a hexagonal layout is here shown attached, but distant to the media device by means of the connector, reference numeral 19.

Additionally, the display unit may be placed on the bottom, on top of or on any side of said media device.

The media device itself, reference numerals 23 through 26, may be a personal computer, a television, a camera, a video camera, a game unit or a mobile unit, such as a mobile telephone, a pad, etc.

On said media device, one or more sensors, indicated by reference numerals 41, may be positioned in order to locate the position(s) of one or more display units attached to, close to, distant to or on the display area of said media device. Said sensor(s) is/are then used—by receiving signal(s) sent from one or more transmitters positioned on or integrated in the display unit—to determine the location of the display unit(s). In other words, by means of said sensor(s), the media device may locate said display unit(s).

Subsequently, the media device may then determine information (dependent on said location) representing content which has to be transferred and presented on said display units.

Said information may be plain text, pictures, frames, video, word-processor data, spread-sheet data, game figures, game elements, text or picture messages, and combinations thereof.

The information (presented on said display units) may further be dependent on what is currently presented on the media device, because it may be convenient to present a part of what is currently presented on the media device—on an enlarged scale or in a different shape—on said display units.

FIG. 5 shows a method of presenting content by means of a display unit.

In step 90, the method in accordance with a preferred embodiment of the invention is started. Variables, flags, buffers, etc., keeping track of locations, content, information item(s), identifying signal(s), etc corresponding to the status of display units located relative to a media device and corresponding to the status of said media device are set to default values. When the method is started a second time, only corrupted variables, flags, buffers, etc. are reset to default values.

Throughout the application—when the wording “presentation”, “present” or the like is used—this is intended to designate that content may be displayed on a corresponding display of the display unit. And furthermore—in case that content is suitable to be emitted through a loudspeaker, i.e. when said content comprises sounds and/or music—content is also played back. This is possible because said display unit may comprise a loudspeaker or a like device.

The wording “content” is meant to be information which is typically displayed and or played back on a personal computer, a television, a video camera, a camera, a game unit, or on a mobile telephone. Said information or content may be plain text, pictures, frames, video, word-processor data, spread-sheet data, game figures, game elements, text or picture messages, and combinations thereof.

In step 100, the display unit may be connected or attached to a first location relative to a media device. This will typically be a user action in that the user may desire that the selected shape of the display and its location, subsequently—in the steps to follow—shall determine what content part or parts from the media device that is or are to be displayed and or played back on said display unit.

It may be the case that this step is repeated for more display units. The steps to follow may then apply correspondingly.

Said display unit may be connected close to or on the display area of said media device or placed at its bottom, top or on any of its sides, i.e. said connection to the first location. The display unit may also be connected within the area or on the edge of the display of the media device; this may alternatively represent said first location.

Furthermore, the display unit may be attached or connected distant to the media device by means of the previously mentioned connector, reference numeral 19, or even by a cable having a connector compatible with said connector; this may further alternatively represent said first location.

In step 200, the media device may determine the first location of the display unit. Step 200 constitutes a generalisation of steps 300, 400 and 500.

In step 300, at least one transmitter—located on the display unit—may transmit a corresponding signal identifying the display unit. As discussed in FIG. 1, one or more transmitters may be positioned on or integrated in the display unit. This or these transmitters may then be used to inform the media device that said display unit is connected to it. Said signal may be used to identify the display unit, its type, layout and/or shape.

In step 400, at least one sensor may receive at least one identifying signal. Said sensor or sensors may be located on the media device. As discussed in the foregoing step and in FIG. 1, the identifying signal(s) is/are transmitted from one or more transmitters located on the display unit.

In step 500, the media device may determine the first location of the display unit based on at least one identifying signal. In other words, in this step the media device—based on one or more of the identifying signals—may determine specific X, Y, Z coordinates of the display unit. Said coordinates may be defined relative to a fixed point on the media device and measured by it by means of received identifying signal(s).

In other words, in the steps 300, 400 and 500, the media device may determine the location of the display unit attached or connected relative to itself.

In step 600, the media device may determine a first information item representing content. Said first information item may be dependent on said determined location and content presented on the media device.

Said first information item may comprise plain text, pictures, frames, video, word-processor data, spread-sheet data, game figures, game elements, text or picture messages, or any combination thereof because it may be derived partly from what is presented on the media device.

In step 700, the media device may transfer said first information item to the display unit. Said first information item may be transferred to the connector of the display unit. Said first information item may have been transferred and then received by means of a network—as a general solution known from the prior art—or it may be received by means of an optimized communication dedicated to the display unit.

In step 800, the display unit may receive and then present said first information item on the display unit. As previously discussed, the wording “present” is meant to be “display” and/or “playback” content, i.e. the first information item, on the display unit.

By means of the above-mentioned steps, the following examples will show the use of the invention:

### EXAMPLE 1

Martin is 32 years of age and addicted to everything relating to aeroplanes. Using his computer, he plays flight simulator games with friends. Attaching extra display units to his screen enables Martin to move certain in-game status frames such as the radar view off-screen to the displays unit's screen space. The display units are attached by snapping them on the side of the computer display. The software in the primary screen, i.e. the media system, then automatically recognises the attached screen, i.e. the display unit, and its location and transfers the in-game status frame closest to the display unit's location to the display unit's screen or display space.

### EXAMPLE 2

Martin's friend Lisa uses one or more extra displays units to be able to work on her computer at home while simultaneously watching her friend's web-cam images on said displays unit(s). Said web-cam images would otherwise have to be presented on the primary display's screen space, i.e. the media system, on top of the other content.

In step 900, the display unit may be disconnected from the first location. As a consequence,—when performing the above-mentioned steps—the media device will detect that said display unit is no longer connected.

In step 1000, the display unit may now be connected to a second location different from the previous first location relative to a media device. This will typically be a user action in that the user may desire that the new, second location shall determine what new content part or parts from the media device is now to be displayed and or played back on said display unit.

It may be the case that this step is repeated for more repositioned display units.

Usually, the method will start all over again as long as the media device and at least one display unit are powered. Otherwise, the method may terminate in step 1100; however, when the media system is powered again, etc., the method may proceed from step 100.

Said media device may be a personal computer, a television, a camera, a video camera, a game unit, a mobile telephone, a pad, etc., capable of detecting said location(s) of a display unit, and capable of subsequently transferring a corresponding content part to said display unit.

Correspondingly, the display unit is connectable and/or attachable to the media device, or it may be placed relative to the media device and connected to it, and furthermore, the display unit is capable of receiving, displaying and/or playing back content from the media device.

A computer-readable medium may be a magnetic tape, an optical disc, a digital video disk (DVD), a compact disc (CD recordable or CD writeable), a mini-disc, a hard disk, a floppy disk, a smart card, a PCMCIA card, etc.

1. A method of presenting content by means of a display unit, the method comprising the steps of:
connecting or attaching the display unit to a first location relative to a media device;
determining, by the media device, the first location of the display unit;
determining, by the media device, a first information item representing content, wherein said first information item is dependent on said location and a content presented on the media device;
transferring, by the media device, the first information item to the display unit; and
receiving and presenting said first information item on the display unit.

2. A method as claimed in claim 1, characterized in that the step of determining the first location of the display unit comprises the steps of:
transmitting, by at least one transmitter located on the display unit, at least one signal identifying said display unit;
receiving, by at least one sensor located on the media device, at least one identifying signal; and
determining, by the media device, the first location based on at least one identifying signal.

3. A method as claimed in claim 1, characterized in that the method further comprises the steps of:
disconnecting the display unit from the first location; and
connecting the display unit to a second location relative to the media device.

4. A method as claimed in claim 1, characterized in that the media device is a personal computer, a television, a camera, a video camera, a game unit or a mobile unit.

5. A computer system for performing the method as claimed in claim 1.

6. A computer program product comprising program code means stored on a computer readable medium for performing the method of claim 1 when the computer program is run on a computer.

7. A display unit for presenting content, said display unit comprising:
means for connecting or attaching to a first location relative to a media device;
means for transmitting, by at least one transmitter located on the display unit, at least one signal identifying said display unit; and
means for receiving and means for presenting a first information item representing content, wherein the first information item is dependent on said location and a content presented on the media device, and wherein said first information item is sent from the media device.
